(19) United States
(12) Patent Application Publication
(10) Pub. No.: US 2025/0135777 A1
(43) Pub. Date: May 1, 2025

(54) LIQUID DISCHARGE HEAD, LIQUID DISCHARGE DEVICE, AND LIQUID DISCHARGE APPARATUS

(71) Applicant: Ryo KASAHARA, KANAGAWA (JP)

(72) Inventor: Ryo KASAHARA, KANAGAWA (JP)

(21) Appl. No.: 18/926,827

(22) Filed: Oct. 25, 2024

(30) Foreign Application Priority Data
Oct. 27, 2023 (JP) 2023-185017

(51) Int. Cl. B41J 2/14; B41J 2/045

(52) U.S. Cl. CPC B41J 2/14274; B41J 2/04581; B41J 2/1433

(57) ABSTRACT

A liquid discharge head includes a nozzle plate, a channel plate, piezoelectric elements, and a diaphragm. The nozzle plate has a nozzle array having nozzles from which liquid droplets are dischargeable. The channel plate has pressure chambers respectively communicating with the nozzles. The piezoelectric elements apply pressures to the respective pressure chambers to discharge the liquid droplets. The diaphragm seals one face of the pressure chambers. The diaphragm includes protruding portions to receive pressures from the respective piezoelectric elements and diaphragm portions to vibrate by the pressures applied by the piezoelectric elements via the respective protruding portions. The piezoelectric elements are disposed opposite to the pressure chambers with the diaphragm in between. Widths of the protruding portions in a center portion of the nozzle array in a nozzle array direction are larger than widths of the protruding portions in each ends of the nozzle array in the nozzle array direction.

### CROSS-REFERENCE TO RELATED APPLICATIONS

This patent application is based on and claims priority pursuant to 35 U.S.C. § 119(a) to Japanese Patent Application No. 2023-185017, filed on Oct. 27, 2023, in the Japan Patent Office, the entire disclosure of which is hereby incorporated by reference herein.

### BACKGROUND

### Technical Field

Embodiments of the present disclosure relate to a liquid discharge head, a liquid discharge device, and a liquid discharge apparatus.

### Related Art

A liquid discharge apparatus is known that discharges liquid droplets. Such a liquid discharge apparatus includes a liquid discharge device that discharges liquid as liquid droplets. The liquid discharge device includes a liquid discharge head. The liquid discharge head includes a nozzle plate, a liquid chamber plate, a diaphragm, and laminated piezoelectric elements. The laminated piezoelectric elements change the pressure inside liquid chambers such that the liquid in the liquid chambers is discharged as liquid droplets from nozzles.

The liquid discharge head includes nozzle arrays in each of which multiple nozzles are arranged. Liquid droplets are discharged from each nozzles included in the nozzle arrays. In such a liquid discharge head in the art, the response time of the laminated piezoelectric elements differs between the laminated piezoelectric elements disposed on ends of the nozzle array in a nozzle array direction and the laminated piezoelectric elements disposed on a center portion of the nozzle array.

### SUMMARY

In an embodiment of the present disclosure, a liquid discharge head includes a nozzle plate, a channel plate, multiple piezoelectric elements, and a diaphragm. The nozzle plate has a nozzle array having multiple nozzles, arrayed in a nozzle array direction, from which liquid droplets are dischargeable. The channel plate has multiple pressure chambers respectively communicating with the multiple nozzles. The multiple piezoelectric elements respectively apply pressures to the multiple pressure chambers to discharge the liquid droplets from the multiple nozzles. The diaphragm seals one face of the multiple pressure chambers. The diaphragm includes multiple protruding portions and multiple diaphragm portions. The multiple protruding portions respectively receive the pressures from the multiple piezoelectric elements. The multiple diaphragm portions vibrate by the pressures applied by the multiple piezoelectric elements via the multiple protruding portions, respectively. The multiple piezoelectric elements are disposed opposite to the multiple pressure chambers with the diaphragm in between. Widths of the multiple protruding portions in a center portion of the nozzle array in the nozzle array direction are larger than widths of the multiple protruding portions in each ends of the nozzle array in the nozzle array direction.

In another embodiment of the present disclosure, a liquid discharge device includes the liquid discharge head, a driving integrated circuit to control the piezoelectric elements of the liquid discharge head, and a frame holding the liquid discharge head.

In still another embodiment of the present disclosure, a liquid discharge apparatus includes the liquid discharge device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of a liquid discharge device according to an embodiment of the present disclosure;

FIG. 2 is an enlarged cross-sectional view of a part of a liquid discharge head as an internal component of the liquid discharge device of FIG. 1, according to an embodiment of the present disclosure;

FIG. 3 is a graph illustrating a correlation between response times of laminated piezoelectric elements and discharge speeds from nozzles corresponding to positions of the nozzles in a nozzle array direction, according to an embodiment of the present disclosure; and

FIG. 4 is a diagram illustrating an overall configuration of a liquid discharge apparatus including multiple liquid discharge devices according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

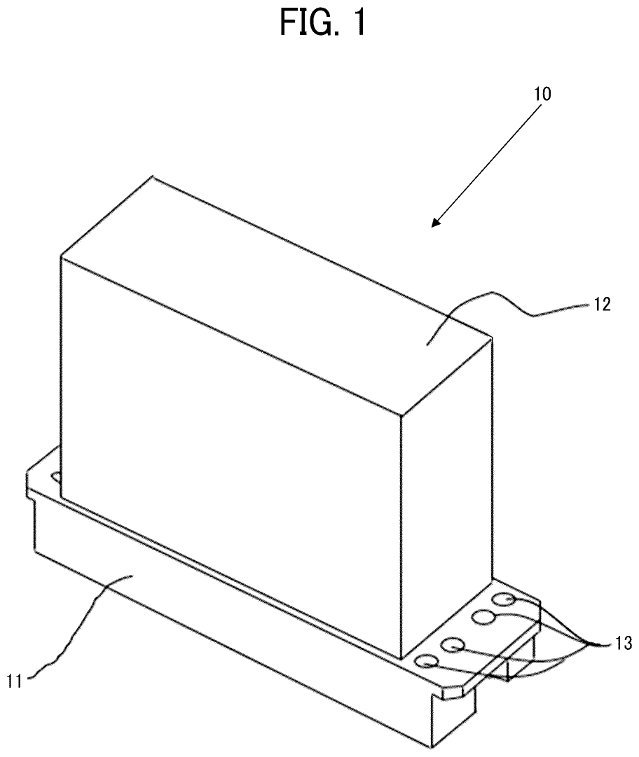

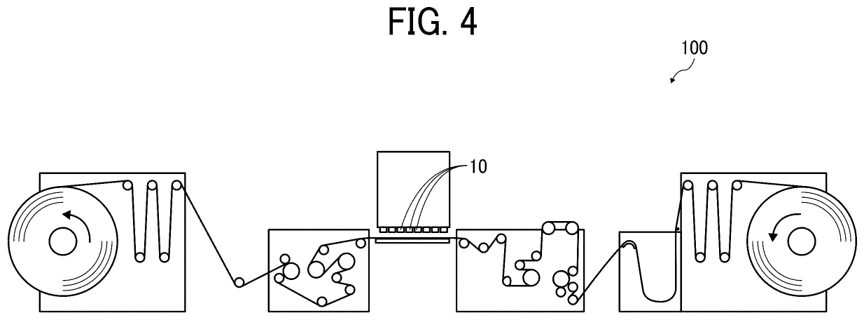

Embodiments of a liquid discharge head, a liquid discharge device, and a liquid discharge apparatus are described with reference to the drawings. FIG. 1 is a perspective view of a liquid discharge device 10 according to an embodiment of the present disclosure. As illustrated in FIG. 1, the liquid discharge device 10 has a housing formed by a head frame 11 as a support and a head cover 12. The liquid discharge device 10 includes multiple liquid supply ports 13 through which liquid flows into the inside of the liquid discharge device 10. FIG. 4 is a diagram illustrating an overall configuration of a liquid discharge apparatus 100 including the multiple liquid discharge devices 10.

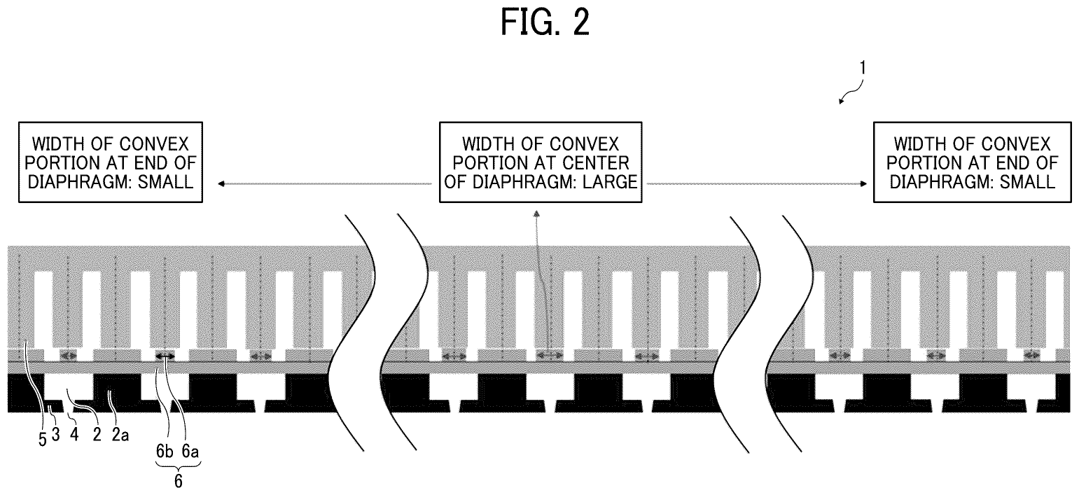

FIG. 2 is an enlarged cross-sectional view of a part of a liquid discharge head 1 as an internal component of the liquid discharge device 10. As illustrated in FIG. 2, the liquid discharge head 1 typically includes pressure chambers 2 and laminated piezoelectric elements 5. Each of the laminated piezoelectric elements 5 applies pressure to corresponding one of the pressure chambers 2 to perform a droplet discharge operation. The liquid discharge head 1 includes a nozzle plate 3, a channel plate 2a, and a diaphragm 6 stacked in this order from bottom to top. Multiple nozzles 4 from which liquid droplets are discharged are formed on the nozzle plate 3. Multiple pressure chambers 2 are formed on the channel plate 2a. Each of the pressure generating chambers 2 communicates with corresponding one of the nozzles 4. The diaphragm 6 seals one face of the pressure chambers 2. The laminated piezoelectric elements 5 apply pressure to the diaphragm 6 to vibrate the diaphragm 6.

The diaphragm 6 includes protruding portions 6a and diaphragm portions 6b. The protruding portions 6a receive pressure from the respective laminated piezoelectric elements 5. The diaphragm portions 6b vibrate upon receiving the pressure from the respective laminated piezoelectric elements 5.

The liquid discharge head 1 includes multiple nozzle arrays arranged at high density, and multiple laminated piezoelectric elements 5, arranged for each of the nozzle arrays. The laminated piezoelectric elements 5 serve as pressure-generating sources for discharging liquid droplets.

The liquid discharge head 1 further includes a flexible printed circuit (FPC), a driving integrated circuit (IC), a head frame 11, and the liquid supply ports 13. The FPC receives electric signals from a host device and transmits the electrical signals to the laminated piezoelectric elements 5. The driving IC is connected to the FPC and controls driving of the laminated piezoelectric elements 5. The head frame 11 holds and fixes the liquid discharge head 1. Liquid to be discharged is supplied through the liquid supply ports 13 from outside of the liquid discharge head 1.

In the liquid discharge head 1, when one nozzle array including the nozzles 4 arranged on the nozzle plate 3 is focused, the response time of the laminated piezoelectric elements 5 differs between the laminated piezoelectric elements 5 disposed on ends of the nozzle array in a nozzle array direction and the laminated piezoelectric elements 5 disposed on a center portion of the nozzle array in the nozzle array direction. In particular, the liquid discharge head 1 can minimize the difference in the discharge speed, which is caused when the discharge speed of the laminated piezoelectric elements 5 disposed on the center portion of the nozzle array is slow and the discharge speed continuously increases toward both ends of the nozzle array in the nozzle array direction.

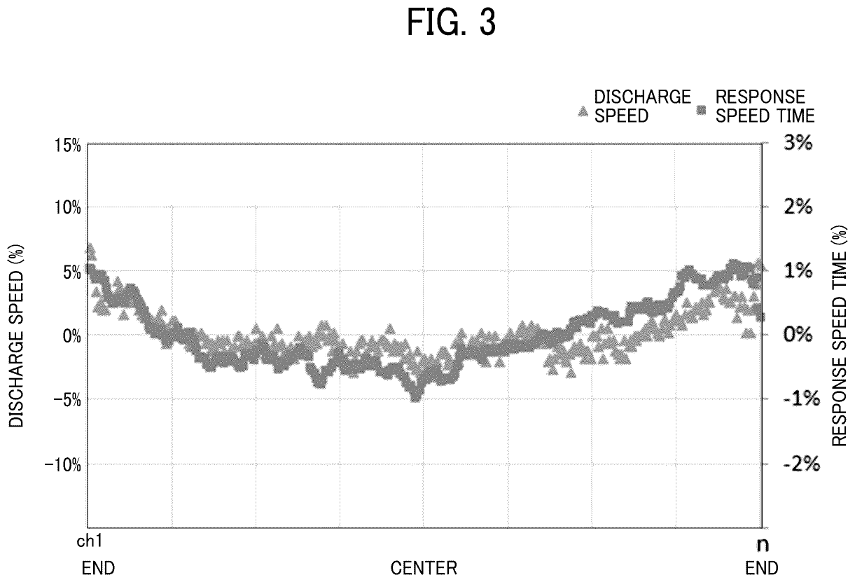

FIG. 3 is a graph illustrating a correlation between response times of the laminated piezoelectric elements 5 and the discharge speeds from the nozzles 4 corresponding to positions of the nozzles 4 in the nozzle array direction. In FIG. 3, the horizontal axis represents the positions of the nozzles 4 in the nozzle array direction, and the vertical axis represents the discharge speeds from the nozzles 4 and the response times of the laminated piezoelectric elements 5. In the correlation between the response time of the laminated piezoelectric elements 5 and the discharge speed from the nozzles 4 corresponding to positions of the nozzles 4 in the arrangement direction of the nozzle array illustrated in FIG. 3, the response time increases toward both ends of the nozzle array and the discharge speed decreases toward both ends of the nozzle array. In addition, FIG. 3 indicates that as the response time increases from the center portion of the nozzle array toward both ends of the nozzle array, the discharge speed increases from the center portion of the nozzle array toward both ends of the nozzle array in correlation with the response time.

In other words, the shorter the response time, which correlates with the timing at which the laminated piezoelectric element 5 pushes out liquid droplets, the slower the discharge speed from the nozzles 4 of the nozzle array. By contrast, the longer the response time, the faster the discharge speed.

For this reason, in the liquid discharge head 1 illustrated in FIG. 2, the response time, which correlates with the timing at which the laminated piezoelectric element 5 pushes out liquid droplets, relatively decreases in the center portion of the nozzle array and relatively increases in both ends of the nozzle array.

In other words, the widths of the protruding portions 6a in the center portion of the diaphragm 6, i.e., the center portion of the nozzle array in the nozzle array direction, are relatively larger than the widths of the protruding portions 6a in both ends of the nozzle array in the nozzle array direction. The widths of the protruding portion 6a continuously decrease from the center portion of the nozzle array toward the ends of the nozzle array. Accordingly, the pressures in the pressure chambers 2 in the center portion of the nozzle array, in which the widths of the protruding portions 6a are relatively larger than the widths of the protruding portions 6a in both ends of the nozzle array, are larger than the pressures in the pressure chambers 2 in both ends of the nozzle array in the nozzle array direction when identical voltage is applied to each of the multiple piezoelectric elements. Accordingly, the discharge speed of liquid droplets from the nozzles 4 in the center portion of the nozzle array increases compared with the discharge speed of liquid droplets from the nozzles 4 in both ends of the nozzle array.

In other words, in the diaphragm 6 of the liquid discharge head 1, the size of the protruding portions 6a, which press the respective diaphragm portions 6b, is relatively larger in the center portion of the nozzle array than the size of the protruding portions 6a in the ends of the nozzle array.

The widths of the protruding portions 6a continuously decrease from the center portion of the nozzle array toward both ends of the nozzle array. Accordingly, the pressure in the pressure chambers 2 continuously decrease from the center portion of the nozzle array toward both ends of the nozzle array. Accordingly, the discharge speed does not relatively and continuously decrease from the center portion of the nozzle array toward both ends of the nozzle array.

In other words, the response time of the laminated piezoelectric elements 5 and the discharge speed of liquid droplets from the nozzles 4 correlate with the timing at which the laminated piezoelectric elements 5 push out liquid droplets. Accordingly, in the liquid discharge head 1, the laminated piezoelectric elements 5 that have slower discharge speeds and shorter response times in the center portion of the nozzle array and the laminated piezoelectric elements 5 that have faster discharge speeds and longer response times are combined on the diaphragm 6. Such a configuration as described above allows the liquid discharge head 1 to reduce the difference in the discharge speed from the nozzles 4 on the nozzle array, and liquid droplets to be discharged in a stable manner.

Embodiments of the present disclosure are not limited to the above-described embodiments, and various modifications can be made without departing from the technical scope of the present disclosure. The above-described embodiments and modifications are some examples, and various modifications and variations can be practiced from such examples by those skilled in the art. Such modifications are included in the technical scope described in the scope of claims.

Aspects of the present disclosure are, for example, as follows.

### First Aspect

A liquid discharge head includes a nozzle plate having a nozzle array having multiple nozzles, arrayed in a nozzle array direction, from which liquid droplets are dischargeable, a channel plate having pressure chambers communicating with the respective nozzles, a diaphragm to seal one face of the pressure chambers, and laminated piezoelectric elements as pressure-generation sources disposed facing the respective pressure chambers with the diaphragm interposed between the laminated piezoelectric elements and the pressure chambers to generate pressure to discharge liquid droplets. The liquid discharge head includes the multiple laminated piezoelectric elements corresponding to the nozzles. The widths of protruding portions of the diaphragm vary based on a correlation between the response times of the multiple laminated piezoelectric elements and the discharge speeds of liquid droplets from the nozzles to minimize the difference in the discharge speeds of liquid droplets from the nozzles of the nozzle array.

### Second Aspect

In the liquid discharge head according to the first aspect, the discharge speed decreases when the response times of the laminated piezoelectric elements in the center portion of the nozzle array are long, and the discharge speed decreases when the response times of the laminated piezoelectric elements continuously increase toward the ends of the nozzle array. The discharge speed is faster when widths of the protruding portions in the center portion of the nozzle array in the nozzle array direction are larger than widths of the protruding portions in each ends of the nozzle array in the nozzle array direction to increase the pressure in the pressure chambers. The discharge speed is slower when the laminated piezoelectric elements are disposed such that the widths of the protruding portions continuously decrease toward each ends of the nozzle array to decrease the pressure in the pressure chambers.

### Third Aspect

A liquid discharge device includes a drive integrated circuit (IC) to control driving of the laminated piezoelectric elements based on signals transmitted from a host device, and a support to hold and fix the liquid discharge head according to the first aspect.

### Fourth Aspect

A liquid discharge apparatus includes the liquid discharge device according to the third aspect.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A liquid discharge head comprising:
a nozzle plate having a nozzle array having multiple nozzles, arrayed in a nozzle array direction, from which liquid droplets are dischargeable;
a channel plate having multiple pressure chambers respectively communicating with the multiple nozzles;
multiple piezoelectric elements to respectively apply pressures to the multiple pressure chambers to discharge the liquid droplets from the multiple nozzles;
a diaphragm to seal one face of the multiple pressure chambers, the diaphragm including:
multiple protruding portions to respectively receive the pressures from the multiple piezoelectric elements; and
multiple diaphragm portions to vibrate by the pressures applied by the multiple piezoelectric elements via the multiple protruding portions, respectively,
wherein the multiple piezoelectric elements are disposed opposite to the multiple pressure chambers with the diaphragm in between,
widths of the multiple protruding portions in a center portion of the nozzle array in the nozzle array direction are larger than widths of the multiple protruding portions in each ends of the nozzle array in the nozzle array direction.

2. The liquid discharge head according to claim 1,
wherein the widths of the multiple protruding portions in each ends of the nozzle array in the nozzle array direction increases toward the multiple protruding portions in the center portion of the nozzle array in the nozzle array direction.

3. The liquid discharge head according to claim 1,
wherein the pressures applied to the multiple pressure chambers in the center portion of the nozzle array in the nozzle array direction are larger than the pressures applied to the multiple pressure chambers in each ends of the nozzle array in the nozzle array direction when identical voltage is applied to each of the multiple piezoelectric elements.

4. A liquid discharge device comprising:
the liquid discharge head according to claim 1;
circuitry configured to control the multiple piezoelectric elements of the liquid discharge head; and
a frame holding the liquid discharge head.

5. A liquid discharge apparatus comprising the liquid discharge device according to claim 4.
